(19) United States
(12) Patent Application Publication
(10) Pub. No.: US 2023/0209494 A1
(43) Pub. Date: Jun. 29, 2023

(54) USER EQUIPMENT POSITIONING SIGNAL MEASUREMENT AND/OR TRANSMISSION

(71) Applicant: QUALCOMM Incorporated, San Diego, CA (US)

(72) Inventors: Jing DAI, Beijing (CN); Hao XU, Beijing (CN); Chao WEI, Beijing (CN); Min HUANG, Beijing (CN)

(21) Appl. No.: 17/917,345

(22) PCT Filed: May 19, 2020
(86) PCT No.: PCT/CN2020/091008

§ 371 Date: Oct. 6, 2022

(51) Int. Cl. H04W 64/00; H04L 5/00

(52) U.S. Cl. CPC H04W 64/00; H04L 5/0048

(57) ABSTRACT

A user equipment configured for wireless signal exchange includes: a transceiver configured to transmit outbound signals wirelessly and receive inbound signals wirelessly; a memory; and a processor, communicatively coupled to the transceiver and the memory, and configured to at least one of: measure an uplink positioning reference signal received from the transceiver, the uplink positioning reference signal having an uplink channel configuration; or measure a first sidelink positioning reference signal received from the transceiver, the first sidelink positioning reference signal having a first sidelink channel configuration; or send a second sidelink positioning reference signal via the transceiver, the second sidelink positioning reference signal having a second sidelink channel configuration.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax), fifth-generation (5G), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Obtaining the locations of mobile devices that are accessing a wireless network may be useful for many applications including, for example, emergency calls, personal navigation, asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

### SUMMARY

An example user equipment configured for wireless signal exchange includes: a transceiver configured to transmit outbound signals wirelessly and receive inbound signals wirelessly; a memory; and a processor, communicatively coupled to the transceiver and the memory, and configured to at least one of: measure an uplink positioning reference signal received from the transceiver, the uplink positioning reference signal having an uplink channel configuration; or measure a first sidelink positioning reference signal received from the transceiver, the first sidelink positioning reference signal having a first sidelink channel configuration; or send a second sidelink positioning reference signal via the transceiver, the second sidelink positioning reference signal having a second sidelink channel configuration.

Implementations of such a user equipment may include one or more of the following features. The processor is configured to send the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format. The processor is configured to measure the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format. The processor is configured to send the second sidelink positioning reference signal with at least one of resource repetition or beam sweeping. The processor is configured to send the second sidelink positioning reference signal and to implement signal muting on the second sidelink positioning reference signal. The processor is configured to: send the second sidelink positioning reference signal; receive positioning information, from the transceiver, received by the transceiver from another user equipment via a sidelink channel; and send the positioning information to a network entity.

Also or alternatively, implementations of such a user equipment may include one or more of the following features. The processor is configured to receive assistance data from the transceiver and is configured to at least one of measure the first sidelink positioning reference signal based on the assistance data or measure the uplink positioning reference signal based on the assistance data. The assistance data include an expected reference signal time difference value and an uncertainty of the expected reference signal time difference value corresponding to the first sidelink positioning reference signal or the uplink positioning reference signal. The processor is configured to: measure the first sidelink positioning reference signal; determine positioning information from the first sidelink positioning reference signal; and send the positioning information to a network entity via the transceiver. The processor is configured to send the second sidelink positioning reference signal associated with at least one of a user equipment identification, corresponding to the user equipment, or a cell identification.

Another example user equipment configured for wireless signal exchange includes: a transceiver configured to transmit outbound signals wirelessly and receive inbound signals wirelessly; and at least one of: uplink measuring means for measuring an uplink positioning reference signal received from the transceiver, the uplink positioning reference signal having an uplink channel configuration; or sidelink measuring means for measuring a first sidelink positioning reference signal received from the transceiver, the first sidelink positioning reference signal having a first sidelink channel configuration; or sending means for sending a second sidelink positioning reference signal via the transceiver, the second sidelink positioning reference signal having a second sidelink channel configuration.

Implementations of such a user equipment may include one or more of the following features. The user equipment includes the sending means and the sending means are for sending the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format. The user equipment includes the sidelink measuring means and the sidelink measuring means are for measuring the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format. The user equipment includes the sending means and the sending means are for sending the second sidelink positioning reference signal with at least one of resource repetition or beam sweeping. The user equipment includes the sending means and the sending means are for implementing signal muting on the second sidelink positioning reference signal. The user equipment includes the sending means, and the user equipment includes: means for receiving positioning information, from the transceiver, received by the transceiver from another user equipment via a sidelink channel; and means for sending the positioning information to a network entity.

Also or alternatively, implementations of such a user equipment may include one or more of the following features. The user equipment includes means for receiving assistance data from the transceiver, where the user equipment includes the sidelink measuring means and the sidelink measuring means are for at least one of measuring the first sidelink positioning reference signal based on the assistance data or measuring the uplink positioning reference signal based on the assistance data. The assistance data include an expected reference signal time difference value and an uncertainty of the expected reference signal time difference value corresponding to the first sidelink positioning reference signal or the uplink positioning reference signal. The user equipment includes the sidelink measuring means and the user equipment includes: means for determining positioning information from the first sidelink positioning reference signal; and means for sending the positioning information to a network entity. The sending means are for sending the second sidelink positioning reference signal associated with at least one of a user equipment identification, corresponding to the user equipment, or a cell identification.

An example method of wireless sidelink positioning signal exchange includes: measuring, at a user equipment, an uplink positioning reference signal received by the user equipment, the uplink positioning reference signal having an uplink channel configuration; or measuring, at the user equipment, a first sidelink positioning reference signal received by the user equipment, the first sidelink positioning reference signal having a first sidelink channel configuration; or sending a second sidelink positioning reference signal from the user equipment, the second sidelink positioning reference signal having a second sidelink channel configuration.

Implementations of such a method may include one or more of the following features. The method includes sending the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format. The method includes measuring the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format. The method includes sending the second sidelink positioning reference signal with at least one of resource repetition or beam sweeping. The method includes sending the second sidelink positioning reference signal and implementing signal muting on the second sidelink positioning reference signal. The method includes sending the second sidelink positioning reference signal, and the method includes: receiving positioning information by the user equipment from another user equipment via a sidelink channel; and sending the positioning information to a network entity.

Also or alternatively, implementations of such a method may include one or more of the following features. The method includes receiving assistance data, where the method includes at least one of measuring the first sidelink positioning reference signal based on the assistance data or measuring the uplink positioning reference signal based on the assistance data. The assistance data include an expected reference signal time difference value and an uncertainty of the expected reference signal time difference value corresponding to the first sidelink positioning reference signal or the uplink positioning reference signal. The method includes measuring the first sidelink positioning reference signal, and the method includes: determining positioning information from the first sidelink positioning reference signal; and sending the positioning information to a network entity. The method includes sending the second sidelink positioning reference signal associated with at least one of a user equipment identification, corresponding to the user equipment, or a cell identification.

An example non-transitory, processor-readable storage medium includes processor-readable instructions configured to cause a processor of a user equipment to: measure an uplink positioning reference signal received from a transceiver of the user equipment, the uplink positioning reference signal having an uplink channel configuration; or measure a first sidelink positioning reference signal received from the transceiver of the user equipment, the first sidelink positioning reference signal having a first sidelink channel configuration; or send a second sidelink positioning reference signal via the transceiver, the second sidelink positioning reference signal having a second sidelink channel configuration.

Implementations of such a storage medium may include one or more of the following features. The storage medium includes instructions configured to cause the processor to send the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format. The storage medium includes instructions configured to cause the processor to measure the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format. The storage medium includes instructions configured to cause the processor to send the second sidelink positioning reference signal with at least one of resource repetition or beam sweeping. The storage medium includes instructions configured to cause the processor to send the second sidelink positioning reference signal and to implement signal muting on the second sidelink positioning reference signal. The storage medium includes instructions configured to cause the processor to send the second sidelink positioning reference signal, and the storage medium includes instructions configured to cause the processor to: receive positioning information, from the transceiver, received by the transceiver from another user equipment via a sidelink channel; and send the positioning information to a network entity.

Also or alternatively, implementations of such a storage medium may include one or more of the following features. The storage medium includes instructions configured to cause the processor to receive assistance data from the transceiver, where the instructions configured to cause the processor to measure the first sidelink positioning reference signal are configured to cause the processor to at least one of measure the first sidelink positioning reference signal based on the assistance data or measure the uplink positioning reference signal based on the assistance data. The assistance data include an expected reference signal time difference value and an uncertainty of the expected reference signal time difference value corresponding to the first sidelink positioning reference signal or the uplink positioning reference signal. The storage medium includes instructions configured to cause the processor to measure the first sidelink positioning reference signal, and the storage medium includes instructions configured to cause the processor to: determine positioning information from the first sidelink positioning reference signal; and send the positioning information to a network entity via the transceiver. The storage medium includes instructions configured to cause the processor to send the second sidelink positioning reference signal associated with at least one of a user equipment identification, corresponding to the user equipment, or a cell identification.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIGS. 5-7 are simplified diagrams of example techniques for determining a position of a mobile device using information from multiple base stations.

FIG. 8 is a block diagram of an example of the user equipment shown in FIG. 2.

FIG. 9 is a signaling and process flow for measuring uplink positioning reference signals and/or sidelink positioning reference signals at a UE.

FIG. 10 is a signaling and process flow for sending and measuring sidelink positioning reference signals.

FIG. 11 is a block flow diagram of a method of wireless sidelink positioning signal exchange.

### DETAILED DESCRIPTION

Techniques are discussed herein for positioning user equipment using uplink positioning reference signals measured by a UE and/or sidelink positioning reference signals measured by a UE. For example, a UE may transmit an uplink positioning reference signal and a premium UE may receive and measure the uplink positioning reference signal. Also or alternatively, a premium UE may transmit a sidelink positioning reference signal and another premium UE may receive and measure the sidelink positioning reference signal. The measurement of the uplink positioning reference signal may be used to determine a location of the UE sending the uplink positioning reference signal. The measurement of the sidelink positioning reference signal may be used to determine a location of the UE receiving the sidelink positioning reference signal or the UE sending the positioning reference signal. These are examples, and other examples may be implemented.

Items and/or techniques described herein may provide one or more of the following capabilities, as well as other capabilities not mentioned. Positioning accuracy may be improved, e.g., by providing UE reference points for positioning (e.g., in addition to base station reference points). Latency in UE position determination may be reduced. Other capabilities may be provided and not every implementation according to the disclosure must provide any, let alone all, of the capabilities discussed.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink / reverse or downlink / forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

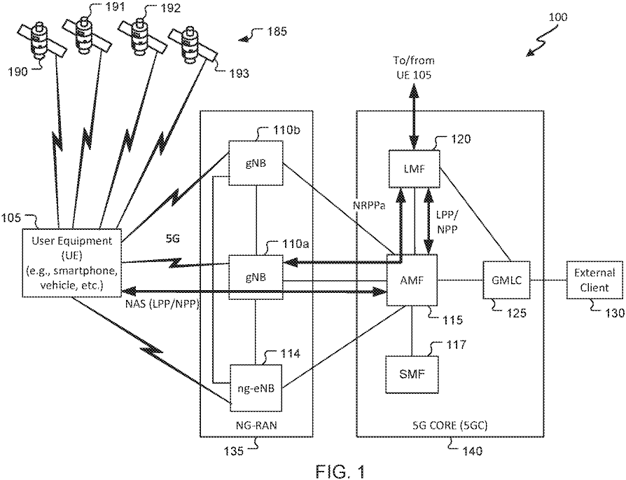

Referring to FIG. 1, an example of a communication system 100 includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, a vehicle, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. The BSs 110a, 110b, 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of the BSs 110a, 110b, 114 may be configured to communicate with the UE 105 via multiple carriers. Each of the BSs 110a, 110b, 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 100b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the BSs 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples only as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the BSs 110a, 110b, 114, the core network 140, and/or the external client 130. For example, such other devices may include internet of thing (IoT) devices, medical devices, home entertainment and/or automation devices, etc. The core network 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the BSs 110a, 110b, 114. The LMF 120 may support positioning of the UE 105 when the UE 105 accesses the NG-RAN 135 and may support position procedures / methods such as Assisted GNSS (A-GNSS), Observed Time Difference of Arrival (OTDOA) (e.g., Downlink (DL) OTDOA or Uplink (UL) OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node / system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the core network 140, and provides QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time Of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE’s position.

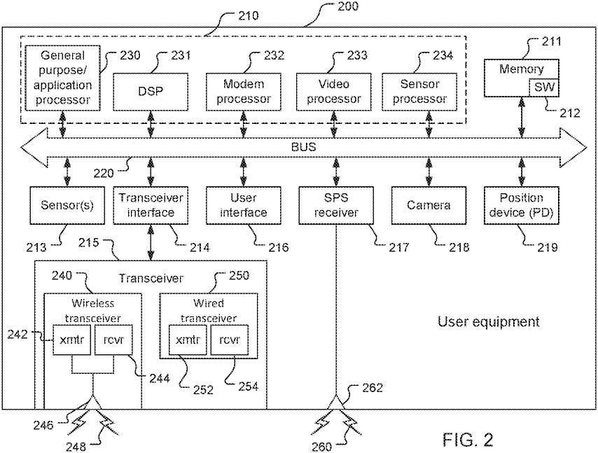

Referring also to FIG. 2, a UE 200 is an example of one of the UEs 112-114 and comprises a computing platform including a processor 210, memory 211 including software (SW) 212, one or more sensors 213, a transceiver interface 214 for a transceiver 215, a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/ application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the invention, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes. The sensor(s) 213 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s), the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer may be a two-dimensional magnetometer configured to detect and provide indications of magnetic field strength in two orthogonal dimensions. Alternatively, the magnetometer may be a three-dimensional magnetometer configured to detect and provide indications of magnetic field strength in three orthogonal dimensions. The magnetometer may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels) and/or receiving (e.g., on one or more downlink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6GHz frequencies. The wired transceiver 250 may include a transmitter 252 and a receiver 254 configured for wired communication, e.g., with the network 135. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer only to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to use one or more other techniques (e.g., relying on the UE’s self-reported location (e.g., part of the UE’s position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion.

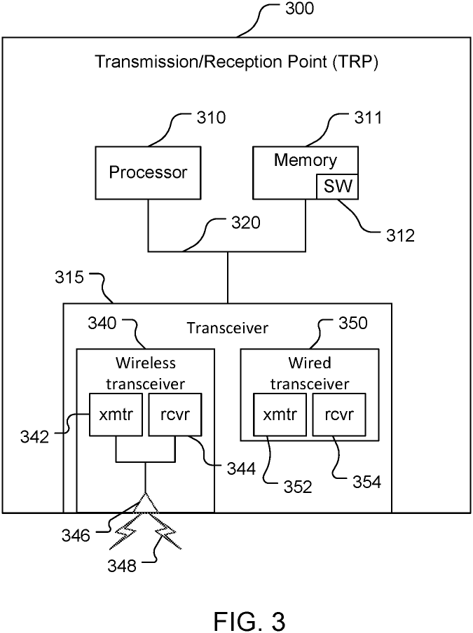

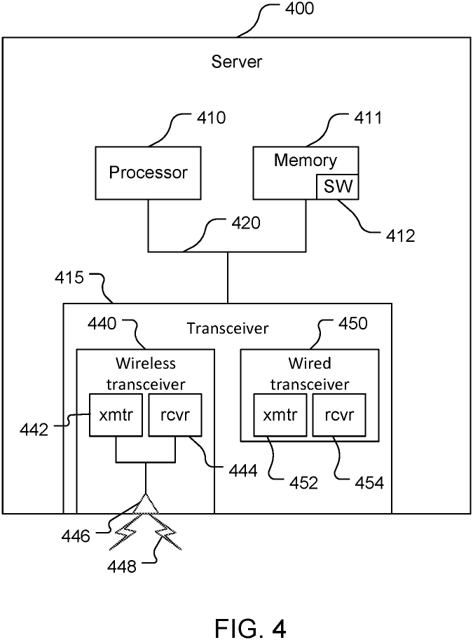

Referring also to FIG. 3, an example of a TRP 300 of the BSs 110a, 110b, 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/ application processor, a DSP, a modem processor, a video processor, and/or a sensor processor as shown in FIG. 4). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels) and/or receiving (e.g., on one or more downlink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the invention, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

Referring also to FIG. 4, a server 400, which is an example of the LMF 120, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/ application processor, a DSP, a modem processor, a video processor, and/or a sensor processor as shown in FIG. 4). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more uplink channels) and/or receiving (e.g., on one or more downlink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the network 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the invention, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix.

One or more of many different positioning techniques (also called positioning methods) may be used to determine position of an entity such as one of the UEs 112-114. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for / receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE’s current downlink timing (e.g., as derived by the UE from a DL signal received from its serving base station), and transmits a common or individual RTT response message (e.g., SRS (sounding reference signal) for positioning, UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal.

Positioning reference signals (PRS) include downlink PRS (DL-PRS) and uplink PRS (UL-PRS) (which may be called SRS (Sounding Reference Signal) for positioning). PRS may comprise PRS resources or PRS resource sets of a frequency layer. A DL-PRS positioning frequency layer (or simply a frequency layer) is a collection of DL-PRS resource sets, from one or more TRPs, that have common parameters configured by higher-layer parameters DL-PRS-PositioningFrequencyLayer, DL-PRS-ResourceSet, and DL-PRS-Resource. Each frequency layer has a DL-PRS subcarrier spacing (SCS) for the DL-PRS resource sets and the DL-PRS resources in the frequency layer. Each frequency layer has a DL-PRS cyclic prefix (CP) for the DL-PRS resource sets and the DL-PRS resources in the frequency layer. Also, a DL-PRS Point A parameter defines a frequency of a reference resource block (and the lowest subcarrier of the resource block), with DL-PRS resources belonging to the same DL-PRS resource set having the same Point A and all DL-PRS resource sets belonging to the same frequency layer having the same Point A. A frequency layer also has the same DL-PRS bandwidth, the same start PRB (and center frequency), and the same value of comb-size.

A TRP may be configured, e.g., by instructions received from a server and/or by software in the TRP, to send DL-PRS per a schedule. According to the schedule, the TRP may send the DL-PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that can span multiple Physical Resource Blocks (PRBs) within N (one or more) consecutive symbol(s) within a slot. A PRB is a collection of REs spanning a quantity of consecutive symbols in the time domain and a quantity of consecutive sub-carriers in the frequency domain. In an OFDM symbol, a PRS resource occupies consecutive PRBs. Each PRS resource is configured with an RE offset, slot offset, a symbol offset within a slot, and a number of consecutive symbols that the PRS resource may occupy within a slot. The RE offset defines the starting RE offset of the first symbol within a DL-PRS resource in frequency. The relative RE offsets of the remaining symbols within a DL-PRS resource are defined based on the initial offset. The slot offset is the starting slot of the DL-PRS resource with respect to a corresponding resource set slot offset. The symbol offset determines the starting symbol of the DL-PRS resource within the starting slot. Transmitted REs may repeat across slots, with each transmission being called a repetition such that there may be multiple repetitions in a PRS resource. The DL-PRS resources in a DL-PRS resource set are associated with the same TRP and each DL-PRS resource has a DL-PRS resource ID. A DL-PRS resource ID in a DL-PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL-PRS resource with other reference signals. The DL-PRS may be configured to be QCL type D with a DL-PRS or SS/PBCH (Synchronization Signal/Physical Broadcast Channel) Block from a serving cell or a non-serving cell. The DL-PRS may be configured to be QCL type C with an SS/PBCH Block from a serving cell or a non-serving cell. The start PRB parameter defines the starting PRB index of the DL-PRS resource with respect to reference Point A. The starting PRB index has a granularity of one PRB and may have a minimum value of 0 and a maximum value of 2176 PRBs.

A PRS resource set is a collection of PRS resources with the same periodicity, same muting patter configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL-PRS configuration including a DL-PRS transmission schedule may be provided to a UE to facilitate (or even enable) the UE to measure the DL-PRS.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS that is received by multiple TRPs instead of sending a separate UL-SRS for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS signal in a PRS/SRS signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS signal pair may be transmitted from the TRP and the UE, respectively, within about 10 ms of each other. With SRS signals being sent by UEs, and with PRS and SRS signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

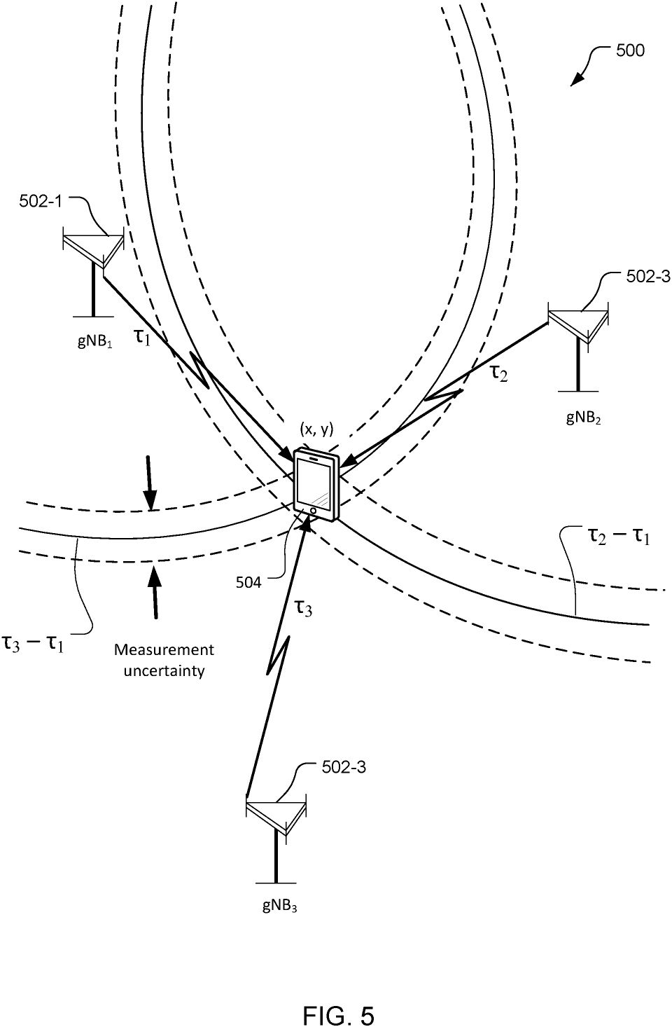

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT). A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Examples of positioning using OTDOA, RTT, and AoD are discussed with respect to FIGS. 5-7, respectively.

Referring to FIG. 5, an example wireless communications system 500 includes base stations 502-1, 502-2, 502-3 and a UE 504. The UE 504 may correspond to any of the UEs described herein, and is configured to calculate an estimated position of the UE 504, and/or assist another entity (e.g., a base station or core network component, another UE, a location server, a third party application, etc.) to calculate an estimate the position of the UE 504. The UE 504 may communicate wirelessly with the base stations 502-1, 502-2, and 502-3, which may correspond to any combination of the base stations described herein, using RF signals and standardized protocols for the modulation of the RF signals and the exchange of information packets. By extracting different types of information from the exchanged RF signals, and utilizing the layout of the wireless communications system 500 (e.g., the locations of the base stations), the UE 504 may determine the position of the UE 504 and/or assist in the determination of the position of the UE 504, in a predefined reference coordinate system. The UE 504 may be configured specify the position of the UE 504 using a two-dimensional (2D) coordinate system and/or a three-dimensional (3D) coordinate system. Additionally, while FIG. 5 illustrates one UE 504 and three base stations 502-1, 502-2, 502-3, more UEs 504 may be used and/or more or fewer base stations may be used.

To support position estimates, the base stations 502-1, 502-2, 502-3 may be configured to broadcast positioning reference signals (e.g., PRS, CRS, etc.) to enable the UE 504 to measure characteristics of such reference signals. For example, the observed time difference of arrival (OTDOA) positioning method is a multi-lateration method in which the UE 504 measures the time difference, known as a reference signal time difference (RSTD), between specific reference signals (e.g., PRS, CRS, CSI-RS, etc.) transmitted by different pairs of network nodes (e.g., base stations, antennas of base stations, etc.) and either reports these time differences to a location server, such as the LMF 120, or computes a location estimate from these time differences.

Generally, RSTDs are measured between a reference network node (e.g., the base station 502-1 in the example of FIG. 5) and one or more neighbor network nodes (e.g., the base stations 502-2 and 502-3 in the example of FIG. 5). The reference network node remains the same for all RSTDs measured by the UE 504 for any single positioning use of OTDOA and would typically correspond to the serving cell for the UE 504 or another nearby cell with good signal strength at the UE 504. Where a measured network node is a cell supported by a base station, the neighbor network nodes would normally be cells supported by base stations different from the base station for the reference cell and may have good or poor signal strength at the UE 504. The location computation can be based on the measured time differences (e.g., RSTDs) and knowledge of the network nodes’ locations and relative transmission timing (e.g., whether network nodes are accurately synchronized or whether each network node transmits with some known time difference relative to other network nodes).

To assist positioning operations, a location server (e.g., the LMF 120) may provide OTDOA assistance data to the UE 504 for the reference network node (e.g., the base station 502-1 in the example of FIG. 5) and the neighbor network nodes (e.g., the base stations 502-2 and 502-3 in the example of FIG. 5) relative to the reference network node. For example, the assistance data may provide the center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell-related parameters applicable to OTDOA. The OTDOA assistance data may indicate the serving cell for the UE 504 as the reference network node.

In some cases, OTDOA assistance data may also include “expected RSTD” parameters that provide the UE 504 with information about the RSTD values that the UE 504 is expected to measure, at the current location of the UE 504, between the reference network node and each neighbor network node, together with an uncertainty of the expected RSTD value. The expected RSTD, together with the associated uncertainty, may define a search window for the UE 504 within which the UE 504 is expected to receive the reference signal for measuring the RSTD value. The search window could be defined in other ways, e.g., by a start time and an end time. OTDOA assistance information may also include reference signal configuration information parameters that help a UE to determine when a reference signal positioning occasion occurs on signals received from various neighbor network nodes relative to reference signal positioning occasions for the reference network node, and to determine the reference signal sequence transmitted from various network nodes in order to measure a signal time of arrival (ToA) or RSTD.

The location server (e.g., the LMF 120) may send the assistance data to the UE 504 and/or the assistance data may originate directly from the network nodes (e.g., the base stations 502-1, 502-2, 502-3), for example in periodically-broadcast overhead messages, etc. Also or alternatively, the UE 504 may be configured to detect neighbor network nodes without the use of assistance data.

Assistance data may be based on a coarse location determined for the UE. For example, E-CID may be used to determine a coarse location for the UE 504 and this coarse location, and known locations of the of the base stations 502-1, 502-2, 502-3 used to determine the expected RSTD values.

The UE 504 may be configured to measure (e.g., based in part on the assistance data) and (optionally) report the RSTDs between reference signals received from pairs of network nodes. Using the RSTD measurements, the known absolute or relative transmission timing of each network node, and the known position(s) of the transmitting antennas for the reference and neighboring network nodes, the network (e.g., the LMF 120, the base stations 502-1, 502-2, 502-3) and/or the UE 504 may estimate a position of the UE 504. More particularly, the RSTD for a neighbor network node “k” relative to a reference network node “Ref” may be given as (ToAₖ - ToA_{Ref}), where the ToA values may be measured modulo one subframe duration (1 ms) to remove the effects of measuring different subframes at different times. In the example of FIG. 5, the measured time differences between the reference cell of base station 502-1 and the cells of neighboring base stations 502-2 and 502-3 are represented as τ₂ - τ₁ and τ₃ - τ₁, where τ₁, τ₂, and τ₃ represent the ToA of a reference signal from the transmitting antenna(s) of base station 502-1, 502-2, and 502-3, respectively. The UE 504 may convert the ToA measurements for different network nodes to RSTD measurements and (optionally) send them to the LMF 120. Using (i) the RSTD measurements, (ii) the known absolute or relative transmission timing of each network node, (iii) the known position(s) of physical transmitting antennas for the reference and neighboring network nodes, and/or (iv) directional reference signal characteristics such as a direction of transmission, the position of the UE 504 may be determined (by the UE 504 and/or the LMF 120).

Still referring to FIG. 5, to obtain a location estimate using OTDOA measured time differences, the network nodes’ locations and relative transmission timing may be provided to the UE 504 by a location server (e.g., the LMF 120). A location estimate for the UE 504 may be obtained (e.g., by the UE 504 and/or by the LMF 120) from OTDOA measured time differences and from other measurements made by the UE 504 (e.g., measurements of signal timing from global positioning system (GPS) or other global navigation satellite system (GNSS) satellites). In these implementations, known as hybrid positioning, the OTDOA measurements may contribute towards obtaining the location estimate for the UE 504 but may not wholly determine the location estimate.

Uplink time difference of arrival (UTDOA) is a similar positioning method to OTDOA, but is based on uplink reference signals (e.g., positioning sounding reference signals (SRS), also called uplink positioning reference signals (UL-PRS)) transmitted by the UE (e.g., UE 504). Further, transmission and/or reception beamforming at the base station 502-1, 502-2, 502-3 and/or the UE 504 may help provide wideband bandwidth at the cell edge for increased precision. Beam refinements may also leverage channel reciprocity procedures in 5G NR.

In NR, coarse time-synchronization across gNBs (e.g., within a cyclic prefix (CP) duration of the OFDM symbols) may be provided. Round-trip-time (RTT)-based methods may use coarse timing synchronization to determine location, and as such, are pratical positioning methods in NR.

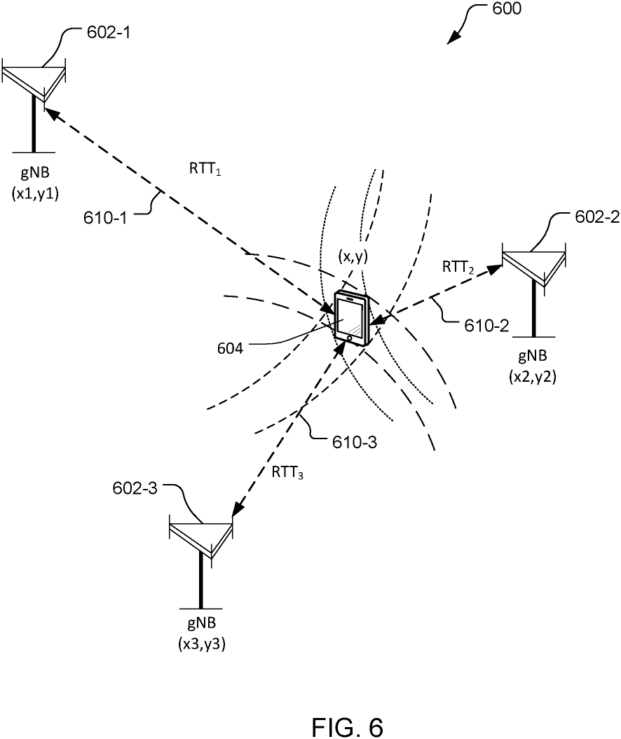

Referring to FIG. 6, an example wireless communications system 600 for multi-RTT-based position determination includes a UE 604 (which may correspond to any of the UEs described herein) and base stations 602-1, 602-2, 602-3. The UE 604 may be configured to calculate an position estimate of the UE 604, and/or to assist another entity (e.g., a base station or core network component, another UE, a location server, a third party application, etc.) to calculate the position estimate of the UE 604. The UE 604 may be configured to communicate wirelessly with the base stations 602-1, 602-2, 602-3 (which may correspond to any of the base stations described herein) using RF signals and standardized protocols for the modulation of the RF signals and the exchange of information packets.

To determine the position (x, y) of the UE 604, the entity determining the position of the UE 604 may use the locations of the base stations 602-1, 602-2, 602-3, which may be represented in a reference coordinate system as (xₖ, yₖ), where k=1, 2, 3 in the example of FIG. 6. Where one of the base stations 602-2 (e.g., the serving base station) or the UE 604 determines the position of the UE 604, the locations of the involved base stations 602-1, 602-3 may be provided to the serving base station 602-2 or the UE 604 by a location server with knowledge of the network geometry (e.g., the LMF 120). Alternatively, the location server may determine the position of the UE 604 using the known network geometry.

Either the UE 604 or the respective base station 602-1, 602-2, 602-3 may determine distances dₖ (where k=1, 2, 3) between the UE 604 and the respective base stations 602-1, 602-2, 602-3. Determining an RTT 610-1, 610-2, 610-3 of signals exchanged between the UE 604 and a respective one of the base stations 602-1, 602-2, 602-3 may be performed and the RTT converted to the distance dₖ. RTT techniques can measure the time between sending a signaling message (e.g., a reference RF signal) and receiving a response. These methods may utilize calibration to remove/reduce processing and/or hardware delays. The processing delays for the UE 604 and the base stations 602-1, 602-2, 602-3 may, in some environments, be assumed to be the same, but may not be accurate.

The distances dₖ may be used by the UE 604, a base station 602-1, 602-2, 602-3, and/or the location server to solve for the position (x, y) of the UE 604 by using a variety of known geometric techniques, such as, for example, trilateration. From FIG. 6, it can be seen that the position of the UE 604 ideally lies at the common intersection of three semicircles, each semicircle being defined by radius dₖ and center (xₖ, yₖ), where k=1, 2, 3.

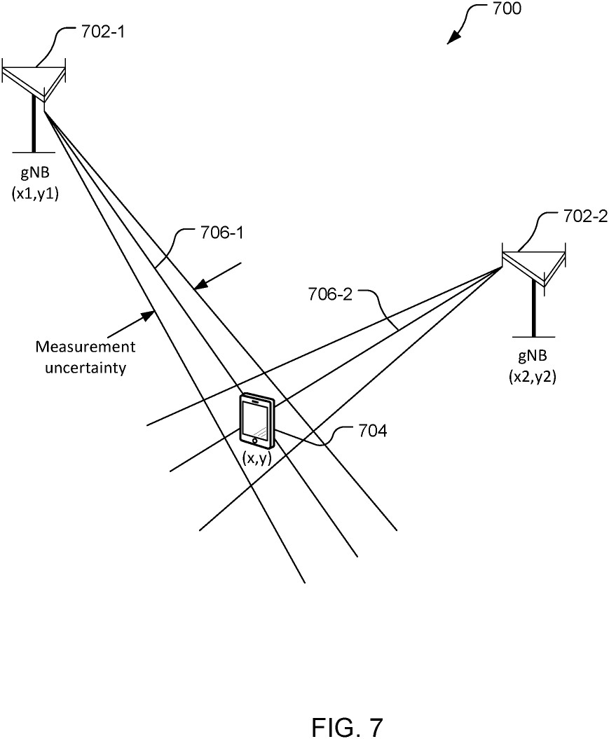

Referring to FIG. 7, a wireless communications system 700 for determining UE position using angle of departure (AoD) information includes base stations 702-1, 702-2, and a UE 704. As shown, RF beams 706-1, 706-2 may be sent by the base stations 702-1, 702-2 in straight lines to the UE 704. The DL AoD, relative to the base stations 702-1, 702-2, of the beams 706-1, 706-2 received by the UE 704 may be determined. The AoD information and the locations of the base stations 702-1, 702-2 may be used to determine an intersection of the beams 706-1, 702-2, including measurement uncertainty for each of the beams 706-1, 706-2, with the intersection corresponding to the location (x, y) of the UE 704. The AoDs may be in a horizontal plane or in three dimensions. While the system 700 illustrates AoD position determination, angle of arrival (AoA) may also be used to determine UE position. For UL AoA position determination, the angle of arrival of beams from the UE 704 at the base stations 702-1, 702-2 may be found, and this information along with the locations of the base stations 702-1, 702-2 may be used to determine the location of the UE 704.

### UE PRS Measurement and/or Transmission

Positioning accuracy (i.e., the accuracy of a determined position estimate) may be improved in a variety of ways. For example, positioning accuracy typically improves as more measurements relative to more reference points (e.g., more TRPs) are obtained. Networks are typically deployed, e.g., with a quantity of TRPs and locations of TRPs, based on expected communication needs, not based on positioning accuracy. A network configured for communication needs may not provide sufficient positioning accuracy. A greater quantity of base stations, and thus TRPs, in a network may provide for higher positioning accuracy, but may come with a significant cost because base stations are expensive. Positioning accuracy may be improved by using UEs as reference points, e.g., through UE-to-UE sidelink positioning signal transmission and/or measurement, thus adding to the number of positioning signal sources and thus the number of reference points. The increased number of reference points may yield, for example, an increased number of ranges to known locations for use in trilateration, resulting in reduced uncertainty in a determined position estimate.

UEs used as reference points may be referred to as premium UEs and may include mobile or stationary UEs. For example, a premium UE may be a roadside unit (RSU) (also known as a roadside equipment (RSE)) that is part of a C-V2X infrastructure (e.g., disposed on a roadside structure such as a lamp post, a building surface, etc.) and may transmit and/or receive PRS to/from other UEs. The premium UE may receive and measure UL-PRS from other UEs, and/or may receive and measure SL-PRS (sidelink PRS) from other UEs, and/or may transmit SL-PRS to other UEs that the other UEs may measure.

A premium UE may differ from a base station in a variety of ways. For example, a premium UE may be configured to communicate with other UEs using one or more sidelink channels (that have different protocols than cell channels), may lack a connection to a wired backhaul, and may lack the ability to configure RRC signaling of other UEs. For example, the premium UE may provide some dynamic information using the sidelink (e.g. scheduling of a sidelink channel or signal like PSSCH (physical sidelink shared channel), or aperiodic sidelink CSI-RS, or aperiodic sidelink SRS) but may not provide semi-static signaling configuration information to other UEs to schedule or control positioning reference signal transmission (e.g., provide semi-static parameters regarding how and when to transmit positioning SRS). A base station, for example, may be configured to configure a UE to transmit positioning SRS periodically, aperiodically, or semi-persistently. For semi-persistent transmissions, the positioning SRS transmission may be triggered by a base station or a premium UE. Cell channels use NR technology and signals sent over cell channels conform to (i.e., are sent in accordance with) different protocols than signals sent over sidelink channels.

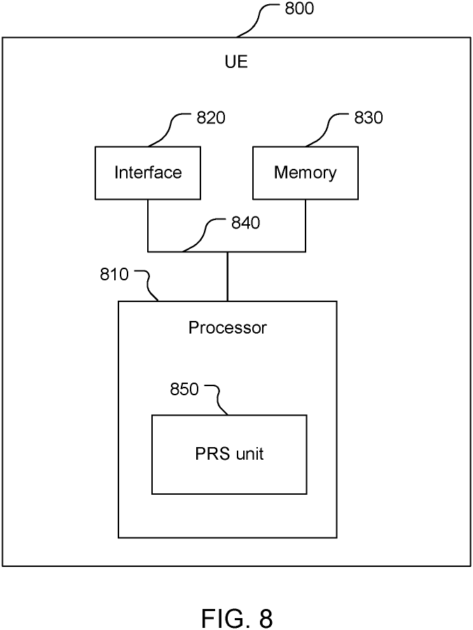

Referring to FIG. 8, with further reference to FIG. 2, a UE 800, which is an example of the UE 200 shown in FIG. 2, includes a processor 810, an interface 820, and a memory 830 communicatively coupled to each other by a bus 840. The UE 800 may include the components shown in FIG. 8, and may include one or more other components such as any of those shown in FIG. 2. The interface 820 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 820 may include the wired transmitter 252 and/or the wired receiver 254. The memory 830 may be configured similarly to the memory 211, e.g., including software with processor-readable instructions configured to cause the processor 810 to perform functions. The description herein may refer only to the processor 810 performing a function, but this includes other implementations such as where the processor 810 executes software (stored in the memory 830) and/or firmware. The description herein may refer to the UE 800 performing a function as shorthand for one or more appropriate components (e.g., the processor 810 and the memory 830) of the UE 800 performing the function. The processor 810 (possibly in conjunction with the memory 830 and, as appropriate, the interface 820) includes a PRS unit 550 configured to measure PRS (e.g., UL-PRS, SL-PRS) and/or configured to transmit PRS, as discussed herein. The PRS unit 850 is discussed further below, and the description may refer to the processor 810 generally, or the UE 800 generally, as performing any of the functions of the PRS unit 850.

The PRS unit 550 may be configured to measure PRS signals. For example, the PRS unit 550 may be configured to measure positioning SRS (UL-PRS) sent by another UE, received by the interface 820 (e.g., the antenna 246 and the wireless receiver 244), and received by the processor 810 from the interface 820. The UL-PRS occupy UL resources, being transmitted on an uplink channel (e.g., PUSCH (physical uplink shared channel), PUCCH (physical uplink control channel)). Also or alternatively, the PRS unit 550 may be configured to measure sidelink positioning reference signals (SL-PRS) received from the interface 820, which were received by the interface 820 (e.g., the antenna 246 and the wireless receiver 244). The SL-PRS, while having an SL configuration (i.e., conforming to an SL protocol) and being transmitted on sidelink, may have a format of UL-PRS or DL-PRS or other (reference) signal, e.g., similar or the same sequence, time-frequency pattern within a slot, and/or pattern over slots (e.g., number of resources, resource time gap, resource repetition factor, muting pattern). As another example, the SL-PRS may be an SL signal repurposed for positioning, such as SL-PSS (SL primary synchronization signal), SL-SSS (SL secondary synchronization signal), SL-CSI-RS (SL channel state information reference signal), SL-PTRS (SL phase tracking reference signal). As another example, the SL-PRS may be a sidelink channel (e.g. PSBCH (physical sidelink broadcast channel), PSSCH (physical sidelink shared channel), PSCCH (physical sidelink control channel), with the corresponding DMRS included or not) repurposed for positioning. The PRS unit 550 may be configured to receive assistance data from a base station and to use the assistance data to measure the received PRS (e.g., positioning SRS or SL-PRS). The assistance data may include, for example, RSTD (including expected RSTD and RSTD uncertainty) for TDOA-based positioning.

Also or alternatively, the PRS unit 550 may be configured to send SL-PRS. The PRS unit 550 may be configured to send SL-PRS to another UE via the interface 820 (e.g., the wireless transmitter 242 and the antenna 246), with the SL-PRS having a sidelink configuration (i.e., being sent in accordance with a sidelink protocol) and being sent on sidelink. The PRS unit 550 may be configured to produce the SL-PRS with a format of or similar to DL-PRS, or of positioning SRS (UL-PRS). As another example, the PRS unit 550 may be configured to produce the SL-PRS as a sidelink reference signal (SL-RS) such as SL-PSS, SL-SSS, SL-CSI-RS, SL-PTRS repurposed for positioning. As another example, the PRS unit 550 may produce the SL-PRS as an SL channel (e.g., PSBCH, PSSCH, PSCCH), repurposed for positioning, with the corresponding DMRS included or not. The PRS unit 550 may be configured to produce the SL-PRS with repetition, beam sweeping (through different SL-PRS resources), and/or muting occasions (i.e., zero-power SL-PRS) similar to DL-PRS.

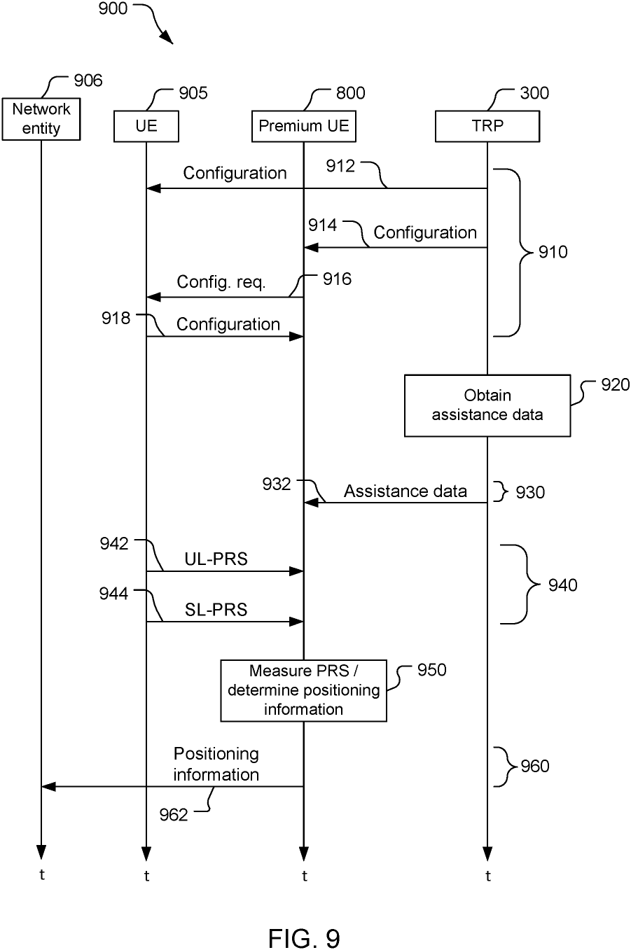

Referring to FIG. 9, with further reference to FIGS. 1-8, a signaling and process flow 900 for measuring uplink positioning reference signals and/or sidelink positioning reference signals at a UE includes the stages shown. The flow 900 is an example only, as stages may be added, rearranged, and/or removed. As non-exhaustive examples, stage 920, stage 930, and/or stage 960 may be omitted. The flow 900 includes interaction of a UE 905 and the UE 800 (i.e., a premium UE capable of measuring and/or transmitting SL-PRS). The UE 905 may be an example of the UE 800 or may be an example of the UE 200 and configured differently than the UE 800, e.g., with the UE 905 not being configured to transmit SL-PRS at stage 940 as discussed below. Either or both of the UEs 905, 800 may, for example, be vehicles (or connected to or integrated with vehicles).

At stage 910, a base station configures the UE 905 for positioning signal transmission. The TRP 300 may send a configuration message 912 to the UE 905 to configure the UE 905 to transmit positioning signals, e.g., UL-PRS and/or SL-PRS. The configuration message 912 may, for example, provide transmission parameters such as a number of resources per PRS resource set, a resource repetition factor, a resource time gap, a muting pattern information, and/or beam sweeping information. The configuration message 912 may include a configuration parameter as to whether the UE 905 is to send PRS information using UL resources and/or using SL resources. The configuration message 912 may include one or more instructions regarding a format of PRS to be transmitted by the UE 905, e.g., whether the PRS transmitted should have a format of UL-PRS, DL-PRS, an SL signal, or another signal such as reference signal (e.g., DMRS). The configuration message 912 may include a user equipment identification, corresponding to the UE 905, and/or a cell identification. The TRP 300 may also send a configuration message 914, with information similar to the information in the configuration message 912, to the UE 800 to configure the UE 800 for reception of the UL-PRS and/or SL-PRS positioning signals.

Optionally at stage 910, the UE 800 may send a configuration request message 916 to the UE 905 and/or the UE 905 may send a configuration message 918 to the UE 800. The configuration request message 916 may, for example, include a request for positioning signal muting (e.g., a requested muting pattern and/or one or more requested measurement gaps) for uplink and/or sidelink PRS. The UE 800 may, for example, determine the requested positioning signal muting based on one or more criteria such as expected interference and/or an importance of positioning signals (e.g., with positioning signals having high importance if the UE 800 is engaged in an emergency call). The UE 905 may determine uplink and/or sidelink positioning signal muting, e.g., to help reduce interference, and produce the configuration message 918 to include the positioning signal muting information. The UE 800 may receive positioning signal muting information from a roadside unit (RSU, also known as roadside equipment (RSE)) such as the TRP 300 or the UE 905.

At stage 920, the TRP 300 obtains assistance data. The TRP 300 may obtain assistance data from the LMF 120 that may determine assistance data to help the UE 800 measure PRS from the UE 905, e.g., to help the UE 905 measure the PRS more accurately, faster, and/or using less processing power than without the assistance data. For example, the LMF 120 may determine a coarse location of the UE 905, e.g., using E-CID and/or another positioning technique. The LMF 120 may use the coarse location of the UE 905, a known location of a source of a reference signal, and a known location of the UE 800 to determine the assistance data. The assistance data may, for example, be a search window as indicated by an expected RSTD value and an expected RSTD uncertainty value (or as indicated by one or more other values). The location of the UE 800 may be determined in a variety of manners, and provided to the LMF 120. For example, the UE 800 may use SPS signals to determine the location of the UE 800 and send the determined location to the LMF 120. As another example, the UE 800 may be placed at a location as part of a network infrastructure deployment and the location of the UE 800 determined in some manner (e.g., using a map, using SPS signals, etc.) and provided to the LMF 120, that provides the location to the TRP 300. The UE 800 may, for example, be stationary, such as being attached to a stationary roadside structure such as a lamp post or a building.

At stage 930, the TRP 300 provides assistance data to the UE 800 in an assistance data message 932. The assistance data may have been determined at stage 920, or may have been otherwise determined and stored in the memory 311.

At stage 940, the UE 905 sends one or more positioning reference signals to the UE 800. For example, the UE 905 may send UL-PRS to the UE 800 in a UL-PRS message 942. The UL-PRS message 942 is sent on a cell channel, e.g., PUSCH, PUCCH, occupying UL-PRS resources. To send the UL-PRS message 942, the UE 905 need not be configured with the PRS unit 550. As another example, in addition to or instead of sending the message 942, the UE 905 may send SL-PRS to the UE 800 in a SL-PRS message 944. The UE 905 may be configured similarly to at least some aspects of the UE 800, e.g., being configured at least to obtain (e.g., produce or retrieve from memory) and send SL-PRS. The SL-PRS message 944 has a sidelink configuration (i.e., is configured in accordance with a sidelink protocol), and is sent on a sidelink channel, occupying SL resources. The sidelink channel used to send the SL-PRS message 944 may be, for example, the PSBCH, PSSCH, or PSCCH. The SL-PRS message 944 may have a format of UL-PRS or DL-PRS or DMRS, etc., which may facilitate implementation of the UE 800 by leveraging (e.g., repurposing) existing UL-PRS, DL-PRS, or DMRS configuration of a UE for use in producing and sending SL-PRS. The SL-PRS message may include a repurposed (e.g., have a format of an) SL-RS such as an SL-PSS, SL-SSS, SL-CSI-RS, or SL-PTRS.

At stage 950, the UE 800 may measure the PRS and may determine positioning information. The UE 800, being a premium UE, is configured to measure (e.g., acquire and decode) UL-PRS and/or is configured to measure SL-PRS, and at stage 950 measures PRS received from the UE 905. The UE 800 may be configured to determine positioning information from one or more received PRS. The positioning information may include one or more PRS measurements and/or information derived from one or more measurements such as one or more pseudoranges, a position of the UE 905, etc. For example, the UE 800 may use the assistance data from the assistance data message 932 to measure the received PRS, e.g., to search for the PRS during a search window indicated by the assistance data and/or to process the PRS based on one or more assistance data parameters to determine positioning information such as a time of arrival of the PRS, a time difference of arrival of the PRS relative to a reference signal, and/or a range from the UE 800 to the UE 905. The UE 800 may use a determined distance between the UE 800 and the UE 905 to help determine the location of the UE 905. Having the UE 800 determine the location of the UE 905 may reduce latency compared to sending measurement information to a network entity such as the LMF 120 to determine the location of the UE 905.

At stage 960, the UE 800 may send at least some of the positioning information to a network entity 906 in a positioning information message 962. The network entity 906 may comprise more than one entity, i.e., the UE 800 may send the positioning information to more than one other entity. The network entity may be a TRP and/or another entity such as a location server, e.g., the LMF 120. The positioning information message 962 may, for example, include a determined location for the UE 905, a raw measurement of the received PRS, and/or a processed measurement (e.g., a ToA, an RSTD, etc.). The network entity 906, such as the LMF 120, may collect positioning information for the same UE 905 corresponding to multiple UEs 800 and determine the location of the UE 905 using the collected information (e.g., multiple distances corresponding to multiple UEs 800, multiple angles of arrival at multiple UEs 800).

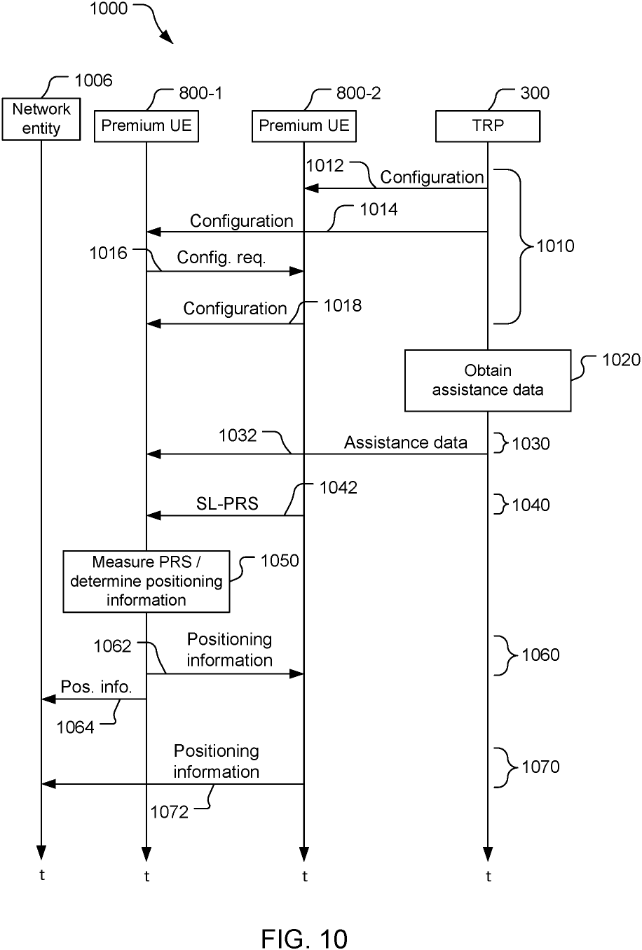

Referring to FIG. 10, with further reference to FIGS. 1-9, a signaling and process flow 1000 for sending and measuring sidelink positioning reference signals includes the stages shown. The flow 1000 is an example only, as stages may be added, rearranged, and/or removed. As two non-exhaustive examples, stage 1020, stage 1030, 1060, and/or stage 1070 may be omitted. UEs 800-1, 800-2 are examples of the UE 800, although the UEs 800-1, 800-2 may be configured differently. For example, the UE 800-1 may be configured to receive and measure SL-PRS and may or may not be configured to send SL-PRS. As another example, the UE 800-2 may be configured to send SL-PRS and may or may not be configured to receive and measure SL-PRS.

At stage 1010, a base station configures the UE 800-2 for positioning signal transmission. The TRP 300 may send a configuration message 1012 to the UE 800-2 to configure the UE 800-2 to transmit SL-PRS positioning signals. The configuration message 1012 may, for example, provide transmission parameters such as a number of resources per PRS resource set, a resource repetition factor, a resource time gap, a muting pattern information, and/or beam sweeping information. The configuration message 1012 may include one or more instructions regarding a format of PRS to be transmitted by the UE 800-2, e.g., whether the PRS transmitted should have a format of UL-PRS, DL-PRS, an SL signal, or another signal such as reference signal (e.g., DMRS). The configuration message 1012 may include a user equipment identification, corresponding to the UE 800-2, and/or a cell identification. The TRP 300 may also send a configuration message 1014, with information similar to the information in the configuration message 1012, to the UE 800-1 to configure the UE 800-1 for reception of the SL-PRS positioning signals.

Optionally at stage 1010, the UE 800-1 may send a configuration request message 1016 to the UE 800-2 and/or the UE 800-2 may send a configuration message 1018 to the UE 800-1. The configuration request message 1016 may, for example, include a request for positioning signal muting (e.g., a requested muting pattern and/or one or more requested measurement gaps) for sidelink PRS. The UE 800-1 may, for example, determine the requested positioning signal muting based on one or more criteria such as expected interference and/or an importance of positioning signals (e.g., with positioning signals having high importance if the UE 800-1 is engaged in an emergency call). The UE 800-2 may determine sidelink positioning signal muting, e.g., to help reduce interference, and produce the configuration message 1018 to include the positioning signal muting information. The UE 800-1 may receive positioning signal muting information from an RSU such as the TRP 300 or the UE 800-2.

At stage 1020, the TRP 300 determines assistance data. The TRP 300 (or another entity such as the LMF 120) may determine assistance data to help the UE 800-1 measure PRS from the UE 800-2, e.g., to help the UE 800-1 measure the PRS more accurately, faster, and/or using less processing power than without the assistance data. For example, the TRP 300 may determine a coarse location of the UE 800-1, e.g., using E-CID and/or another positioning technique. The TRP 300 may use the coarse location of the UE 800-1, a known location of a source of a reference signal, and a known location of the UE 800-2 to determine the assistance data. The UE 800-2 may be a stationary UE, e.g., affixed to a roadside structure, or may be a mobile UE with a known location (e.g., determined and provided to the TRP 300). The assistance data may, for example, be a search window as indicated by an expected RSTD value and an expected RSTD uncertainty value (or as indicated by one or more other values such as a start time and an end time).

At stage 1030, the TRP 300 provides assistance data to the UE 800-1 in an assistance data message 1032. The assistance data may have been determined at stage 1020, or may have been otherwise determined and stored in the memory 311.

At stage 1040, the UE 800-2 sends one or more positioning reference signals to the UE 800-1. For example, the UE 800-2 may send SL-PRS to the UE 800-1 in a SL-PRS message 1042. The UE 800-2 may be configured to obtain (e.g., produce or retrieve from memory) and send the SL-PRS message 1042 with a sidelink configuration (i.e., configured in accordance with a sidelink protocol) on a sidelink channel, occupying SL resources. The sidelink channel used to send the SL-PRS message 1042 may be, for example, the PSBCH, PSSCH, or PSCCH. The SL-PRS message 1042 may have a format of UL-PRS or DL-PRS or DMRS, etc., which may facilitate implementation of the UE 800 by leveraging (e.g., repurposing) existing UL-PRS, DL-PRS, or DMRS configuration of a UE for use in producing and sending SL-PRS. The SL-PRS message may include a repurposed (e.g., have a format of an) SL-RS such as an SL-PSS, SL-SSS, SL-CSI-RS, or SL-PTRS. An SL-PRS resource set of the SL-PRS message 1042 is associated with the UE 800-2.

At stage 1050, the UE 800-1 may measure the PRS and may determine positioning information. The UE 800-1, being a premium UE, is configured to measure (e.g., acquire and decode) SL-PRS, and at stage 1050 measures PRS received from the UE 800-2. The UE 800-1 may use the assistance data to measure the SL-PRS. The UE 800-1 may be configured to determine (e.g., using the assistance data) positioning information (e.g., as discussed above) from one or more received PRS.

At stage 1060, the UE 800-1 may send at least some of the positioning information to the UE 800-2 in a positioning information message 1062. Also or alternatively, the UE 800-1 may send at least some of the positioning information to a network entity 1006 in a positioning information message 1064. The network entity 1006 may comprise more than one entity, i.e., the UE 800-1 may send the positioning information to more than one other entity. The network entity 1006 may be a TRP and/or another entity such as a location server, e.g., the LMF 120. The positioning information message 1062 and/or the message 1064 may, for example, include a determined location for the UE 800-1, a raw measurement of the received PRS, and/or a processed measurement (e.g., a ToA, an RSTD, etc.).

At stage 1070, the UE 800-2 may send positioning information to the network entity 1006 in a positioning information message 1072. The message 1072 may include some or all of the positioning information in the message 1062. The UE 800-2 may, for example, send a PRS measurement and/or a location of the UE 800-1 to the network entity. For example, if the network entity 1006 (e.g., a TRP) is out of communication range of the UE 800-1 but within communication range of the UE 800-2, then the positioning information determined by the UE 800-1 may still reach the network entity 1006 via the UE 800-2. The network entity 1006, such as the LMF 120, may collect positioning information for the same UE 800-1 from multiple UEs 800-2 and determine the location of the UE 800-1 using the collected information (e.g., multiple distances, multiple angles of departure). Also or alternatively, the UE 800-2 may determine a location of the UE 800-1 based on the positioning information in the message 1062 (e.g., multiple ranges corresponding to multiple UEs 800-2, multiple angles of arrival of SL-PRS corresponding to multiple UEs 800-2). Having the UE 800-2 determine the location of the UE 800-1 may reduce latency compared to sending measurement information to a network entity such as the LMF 120 to determine the location of the UE 800-1.

The flow 900 shown in FIG. 9 and the flow 1000 may be combined. That is, the UE 800-1 may be the UE 905 and may transmit the UL-PRS and/or the SL-PRS in addition to measuring the SL-PRS from the UE 800-2, and the UE 800-2 may measure UL-PRS and/or SL-PRS from the UE 800-1 in addition to sending SL-PRS.

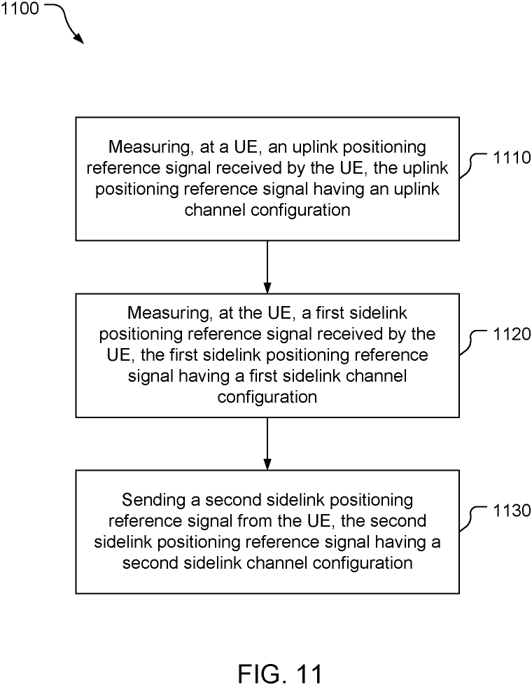

Referring to FIG. 11, with further reference to FIGS. 1-10, a method 1100 of wireless sidelink positioning signal exchange includes the stages shown. The method 1100 is, however, an example only and not limiting. The method 1100 may be altered, e.g., by having stages added, removed, rearranged, combined, performed concurrently, and/or having single stages split into multiple stages. For example, any of stages 1110, 1120, or 1130 may be omitted, with the method 1100 perhaps including only one of the stages 1110, 1120, 1130, or a combination of two of the stages 1110, 1120, 1130 or all three of the stages 1110, 1120, 1130.

At stage 1110, the method 1100 includes measuring, at a user equipment, an uplink positioning reference signal received by the user equipment, the uplink positioning reference signal having an uplink channel configuration. For example, the UE 800 may measure the UL-PRS in the UL-PRS message 942. The UL-PRS may have the traditional format of UL-PRS and occupy UL resources on an uplink channel, e.g., PUSCH, PUCCH. The processor 810 and the memory 830 may comprise means for measuring the uplink positioning reference signal.

At stage 1120, the method 1100 includes measuring, at the user equipment, a first sidelink positioning reference signal received by the user equipment, the first sidelink positioning reference signal having a first sidelink channel configuration. For example, the UE 800 may receive the SL-PRS in the SL-PRS message 944 and determine a characteristic (e.g., RSSI, ToA, RSTD) of the received SL-PRS. The UE 800 may measure the SL-PRS with the SL-PRS having a format of a UL-PRS, a DL-PRS, an SL synchronization signal (e.g., SL-PSS, SL-SSS), an SL-CSI-RS, an SL-PTRS, or an SL-DMRS (i.e., a DMRS of an SL channel). The processor 810 and the memory 830 may comprise means for measuring the first sidelink positioning reference signal.

At stage 1130, the method 1100 includes sending a second sidelink positioning reference signal from the user equipment, the second sidelink positioning reference signal having a second sidelink channel configuration. For example, the UE 800-2 may send SL-PRS in the SL-PRS message 1042 to the UE 800-1. The SL-PRS may have a format of a UL-PRS, a DL-PRS, an SL synchronization signal (e.g., SL-PSS, SL-SSS), an SL-CSI-RS, an SL-PTRS, or an SL-DMRS (i.e., a DMRS of an SL channel such as PSBCH, PSSCH, PSCCH). The second SL-PRS may be sent with at lease one of resource repetition or beam sweeping. For example, the UE 800-2 may cause the SL-PRS to be sent in a beam that changes direction over time and/or with multiple transmissions of the same SL resource. The second SL-PRS may be sent, and signal muting implemented on the SL-PRS. For example, the UE 800-2 may send at least one resource of the second SL-PRS and may mute transmission of (i.e., selectively withhold transmission of) at least one other scheduled resource of the second SL-PRS, i.e., at least one other resource that would be transmitted absent implementation of the muting. The second SL-PRS may be sent associated with a user ID, corresponding to the UE, and/or a cell identification. For example, the UE 800-2 may send the SL-PRS message 1042 with the SL-PRS message 1042 including an ID of the UE 800-2 and a cell ID. The processor 810, the interface 820 (e.g., the wireless transmitter 242 and the antenna 246), and the memory 830 may comprise means for sending the second sidelink positioning reference signal.

The method 1100 may include one or more of the following features. For example, the method 1100 may include receiving positioning information from another UE via a sidelink channel and sending the positioning information to a network entity. For example, the UE 800-2 may receive the positioning information message 1062 in a sidelink channel and send at least some of the positioning information from the message 1062 to the network entity 1006. The processor 810, the interface 820 (e.g., the wireless receiver 244, and the antenna 246), and the memory 830 may comprise means for receiving the positioning information via a sidelink channel. The processor 810, the interface 820 (e.g., the wireless transmitter 242 and the antenna 246, or the wired transmitter 252), and the memory 830 may comprise means for sending the positioning information to the network entity. As another example, the method 1100 may include measuring the first SL-PRS, determining positioning information from the first SL-PRS, and sending the positioning information to a network entity. For example, as shown in and discussed with respect to FIG. 9, the UE 800 may, at stage 950, measure the SL-PRS in the SL-PRS message 944 received on a sidelink channel and determine positioning information. The UE 800 may send the positioning information in the positioning information message 962 to the network entity 906. The processor 810 and the memory 830 may comprise means for determining the positioning information. The processor 810, the interface 820 (e.g., the wireless transmitter 242 and the antenna 246, or the wired transmitter 252), and the memory 830 may comprise means for sending the positioning information to the network entity.

Also or alternatively, the method 1100 may include one or more of the following features. For example, the method 1100 may include receiving positioning assistance data, may include measuring the first sidelink positioning reference signal based on the assistance data and/or measuring the uplink positioning reference signal based on the assistance data. The UE 800 shown in FIG. 9 may receive the assistance data message 932 and use the assistance data in the message 932 to measure the UL-PRS in the message 942 and/or the SL-PRS in the message 944. The UE 800-2 shown in FIG. 10 may receive the assistance data message 1032 and use the assistance data in the message 1032 to measure the SL-PRS in the message 1042. The assistance data may comprise a search window corresponding to the UL-PRS or the SL-PRS. The search window may comprise an expected RSTD and an uncertainty of the expected RSTD. The processor 810, the interface 820 (e.g., the wireless receiver 244 and the antenna 246), and the memory 830 may comprise means for receiving positioning assistance data.

### Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. A statement that a feature implements, or a statement that a feature may implement, a function includes that the feature may be configured to implement the function (e.g., a statement that an item performs, or a statement that the item may perform, function X includes that the item may be configured to perform function X). Elements discussed may be components of a larger system, wherein other rules may take precedence over or otherwise modify the application of the invention. Also, a number of operations may be undertaken before, during, or after above-discussed elements or operations are considered. Accordingly, the above description does not bound the scope of the claims.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B means that the item may be configured to perform the function regarding A, or may be configured to perform the function regarding B, or may be configured to perform the function regarding A and B. For example, a phrase of “a processor configured to measure at least one of A or B” means that the processor may be configured to measure A (and may or may not be configured to measure B), or may be configured to measure B (and may or may not be configured to measure A), or may be configured to measure A and B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation of a processor configured to at least one of A or B means that the processor is configured to A (and may or may not be configured to B) or is configured to B (and may or may not be configured to B) or is configured to A and B, where A is a function (e.g., determine, obtain, or measure, etc.) and B is a function.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

As used herein, unless otherwise stated, a statement that a function or operation is “based on” an item or condition means that the function or operation is based on the stated item or condition and may be based on one or more items and/or conditions in addition to the stated item or condition.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment configured for wireless signal exchange, the user equipment comprising:
a transceiver configured to transmit outbound signals wirelessly and receive inbound signals wirelessly;
a memory; and
a processor, communicatively coupled to the transceiver and the memory, and configured to at least one of:
measure an uplink positioning reference signal received from the transceiver, the uplink positioning reference signal having an uplink channel configuration; or
measure a first sidelink positioning reference signal received from the transceiver, the first sidelink positioning reference signal having a first sidelink channel configuration; or
send a second sidelink positioning reference signal via the transceiver, the second sidelink positioning reference signal having a second sidelink channel configuration.

2. The user equipment of claim 1, wherein the processor is configured to send the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format.

3. The user equipment of claim 1, wherein the processor is configured to measure the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format.

4. The user equipment of claim 1, wherein the processor is configured to send the second sidelink positioning reference signal with at least one of resource repetition or beam sweeping.

5. The user equipment of claim 1, wherein the processor is configured to send the second sidelink positioning reference signal and to implement signal muting on the second sidelink positioning reference signal.

6. The user equipment of claim 1, wherein the processor is configured to:
send the second sidelink positioning reference signal;
receive positioning information, from the transceiver, received by the transceiver from another user equipment via a sidelink channel; and
send the positioning information to a network entity.

7. The user equipment of claim 1, wherein the processor is configured to receive assistance data from the transceiver and is configured to at least one of measure the first sidelink positioning reference signal based on the assistance data or measure the uplink positioning reference signal based on the assistance data.

8. The user equipment of claim 7, wherein the assistance data comprise an expected reference signal time difference value and an uncertainty of the expected reference signal time difference value corresponding to the first sidelink positioning reference signal or the uplink positioning reference signal.

9. The user equipment of claim 1, wherein the processor is configured to:
measure the first sidelink positioning reference signal;
determine positioning information from the first sidelink positioning reference signal; and
send the positioning information to a network entity via the transceiver.

10. The user equipment of claim 1, wherein the processor is configured to send the second sidelink positioning reference signal associated with at least one of a user equipment identification, corresponding to the user equipment, or a cell identification.

11. A user equipment configured for wireless signal exchange, the user equipment comprising:
a transceiver configured to transmit outbound signals wirelessly and receive inbound signals wirelessly; and
at least one of
uplink measuring means for measuring an uplink positioning reference signal received from the transceiver, the uplink positioning reference signal having an uplink channel configuration; or
sidelink measuring means for measuring a first sidelink positioning reference signal received from the transceiver, the first sidelink positioning reference signal having a first sidelink channel configuration; or
sending means for sending a second sidelink positioning reference signal via the transceiver, the second sidelink positioning reference signal having a second sidelink channel configuration.

12. The user equipment of claim 11, wherein the user equipment comprises the sending means and the sending means are for sending the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format.

13. The user equipment of claim 11, wherein the user equipment comprises the sidelink measuring means and the sidelink measuring means are for measuring the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format.

14. The user equipment of claim 11, wherein the user equipment comprises the sending means and the sending means are for sending the second sidelink positioning reference signal with at least one of resource repetition or beam sweeping.

15. The user equipment of claim 11, wherein the user equipment comprises the sending means and the sending means are for implementing signal muting on the second sidelink positioning reference signal.

16. The user equipment of claim 11, wherein the user equipment comprises the sending means, and the user equipment further comprises:
means for receiving positioning information, from the transceiver, received by the transceiver from another user equipment via a sidelink channel; and
means for sending the positioning information to a network entity.

17. The user equipment of claim 11, further comprising means for receiving assistance data from the transceiver, wherein the user equipment comprises the sidelink measuring means and the sidelink measuring means are for at least one of measuring the first sidelink positioning reference signal based on the assistance data or measuring the uplink positioning reference signal based on the assistance data.

18. The user equipment of claim 17, wherein the assistance data comprise an expected reference signal time difference value and an uncertainty of the expected reference signal time difference value corresponding to the first sidelink positioning reference signal or the uplink positioning reference signal.

19. The user equipment of claim 11, wherein the user equipment comprises the sidelink measuring means, the user equipment further comprises:
means for determining positioning information from the first sidelink positioning reference signal; and
means for sending the positioning information to a network entity.

20. The user equipment of claim 11, wherein the sending means are for sending the second sidelink positioning reference signal associated with at least one of a user equipment identification, corresponding to the user equipment, or a cell identification.

21. A method of wireless sidelink positioning signal exchange, the method comprising:
measuring, at a user equipment, an uplink positioning reference signal received by the user equipment, the uplink positioning reference signal having an uplink channel configuration; or
measuring, at the user equipment, a first sidelink positioning reference signal received by the user equipment, the first sidelink positioning reference signal having a first sidelink channel configuration; or
sending a second sidelink positioning reference signal from the user equipment, the second sidelink positioning reference signal having a second sidelink channel configuration.

22. The method of claim 21, wherein the method comprises sending the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format.

23. The method of claim 21, wherein the method comprises measuring the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format.

24. The method of claim 21, wherein the method comprises sending the second sidelink positioning reference signal with at least one of resource repetition or beam sweeping.

25. The method of claim 21, wherein the method comprises sending the second sidelink positioning reference signal and implementing signal muting on the second sidelink positioning reference signal.

26. The method of claim 21, wherein the method comprises sending the second sidelink positioning reference signal, the method further comprising:
receiving positioning information by the user equipment from another user equipment via a sidelink channel; and
sending the positioning information to a network entity.

27. The method of claim 21, further comprising receiving assistance data, wherein the method comprises at least one of measuring the first sidelink positioning reference signal based on the assistance data or measuring the uplink positioning reference signal based on the assistance data.

28. The method of claim 27, wherein the assistance data comprise an expected reference signal time difference value and an uncertainty of the expected reference signal time difference value corresponding to the first sidelink positioning reference signal or the uplink positioning reference signal.

29. The method of claim 21, wherein the method comprises measuring the first sidelink positioning reference signal, and wherein the method further comprises:
determining positioning information from the first sidelink positioning reference signal; and
sending the positioning information to a network entity.

30. The method of claim 21, wherein the method comprises sending the second sidelink positioning reference signal associated with at least one of a user equipment identification, corresponding to the user equipment, or a cell identification.

31. A non-transitory, processor-readable storage medium comprising processor-readable instructions configured to cause a processor of a user equipment to:
measure an uplink positioning reference signal received from a transceiver of the user equipment, the uplink positioning reference signal having an uplink channel configuration; or
measure a first sidelink positioning reference signal received from the transceiver of the user equipment, the first sidelink positioning reference signal having a first sidelink channel configuration; or
send a second sidelink positioning reference signal via the transceiver, the second sidelink positioning reference signal having a second sidelink channel configuration.

32. The storage medium of claim 31, wherein the storage medium comprises instructions configured to cause the processor to send the second sidelink positioning reference signal with an uplink positioning reference signal format, a downlink positioning reference signal format, a sidelink synchronization signal format, a sidelink channel state information reference signal format, a sidelink phase tracking reference signal format, or a sidelink demodulation reference signal format.

33. The storage medium of claim 31, wherein the storage medium comprises instructions configured to cause the processor to measure the first sidelink positioning reference signal with the first sidelink positioning reference signal having an uplink positioning reference signal format, a downlink positioning reference signal format, a sidelink synchronization signal format, a sidelink channel state information reference signal format, a sidelink phase tracking reference signal format, or a sidelink demodulation reference signal format.

34. The storage medium of claim 31, wherein the storage medium comprises instructions configured to cause the processor to send the second sidelink positioning reference signal with at least one of resource repetition or beam sweeping.

35. The storage medium of claim 31, wherein the storage medium comprises instructions configured to cause the processor to send the second sidelink positioning reference signal and to implement signal muting on the second sidelink positioning reference signal.

36. The storage medium of claim 31, wherein the storage medium comprises instructions configured to cause the processor to send the second sidelink positioning reference signal, the storage medium further comprising instructions configured to cause the processor to:
receive positioning information, from the transceiver, received by the transceiver from another user equipment via a sidelink channel; and
send the positioning information to a network entity.

37. The storage medium of claim 31, further comprising instructions configured to cause the processor to receive assistance data from the transceiver, wherein the instructions configured to cause the processor to measure the first sidelink positioning reference signal are configured to cause the processor to at least one of measure the first sidelink positioning reference signal based on the assistance data or measure the uplink positioning reference signal based on the assistance data.

38. The storage medium of claim 37, wherein the assistance data comprise an expected reference signal time difference value and an uncertainty of the expected reference signal time difference value corresponding to the first sidelink positioning reference signal or the uplink positioning reference signal.

39. The storage medium of claim 31, wherein the storage medium comprises instructions configured to cause the processor to measure the first sidelink positioning reference signal, the storage medium further comprising instructions configured to cause the processor to:
determine positioning information from the first sidelink positioning reference signal; and
send the positioning information to a network entity via the transceiver.

40. The storage medium of claim 31, wherein the storage medium comprises instructions configured to cause the processor to send the second sidelink positioning reference signal associated with at least one of a user equipment identification, corresponding to the user equipment, or a cell identification.
